(19) United States
(12) Patent Application Publication
(10) Pub. No.: US 2005/0019142 A1
(43) Pub. Date: Jan. 27, 2005

(54) Boulder moving device and method

(76) Inventors: Marshall Miles, Willcox, AZ (US); Bryan Riggs, Willcox, AZ (US); Donald Riggs, Willcox, AZ (US)

Correspondence Address: Allan W. Watts;SNELL & WILMER LLP, One Arizona Center, 400 East Van Buren, Phoenix, AZ, 85004-2202, US

(21) Appl. No.: 10/898,629

(22) Filed: Jul. 23, 2004

Related U.S. Application Data
(60) Provisional application No. 60/490,021, filed on Jul. 24, 2003.
(60) Provisional application No. 60/514,231, filed on Oct. 23, 2003.

(51) Int. Cl. B60P 3/00

(52) U.S. Cl. 414/460

(57) ABSTRACT

A device for moving heavy objects for use in landscaping, such as boulders. The reduced width of the device facilitates easy placement of heavy objects in hard-to-reach locations. The device includes a structure with an overhead cross bar, a hoist, wheels, a drive mechanism, and a steering mechanism. The drive system may include an engine, and may include a hydraulic system that may also provide steering.

### CROSS-REFERENCE TO RELATED APPLICATION

This application claims priority to, and the benefit of, U.S. Provisional Application Ser. No. 60/490,021 filed Jul. 24, 2003 and entitled “Boulder Moving System and Method” and Ser. No. 60/514,231 filed Oct. 23, 2003 and entitled “Boulder Moving System and Method”, which are hereby incorporated by reference.

### FIELD OF INVENTION

The present invention relates to systems and devices used to transport heavy objects. More specifically, the present invention relates to moving heavy objects used in landscaping such as boulders and equipment.

### BACKGROUND OF THE INVENTION

Landscapers frequently use large equipment to carry objects wherein the equipment must be moved to strategically place heavy items such as, for example, boulders, statues and sculptures. A boulder, statue or sculpture may weigh anywhere from 500 pounds to over 5 tons, making the items difficult to move without the use of a device or machine.

To deliver heavy objects to homes, businesses, parks, and other desired locations, landscapers typically use large cranes mounted to full size trucks. However, trucks capable of supporting a crane range in width from five to seven feet, making it difficult to deliver heavy objects to locations that require navigation of narrow corridors. Furthermore, trucks typically have a large turning radius making them difficult to maneuver in tight areas, such as around trees or pools. For example, it is difficult for a truck with a crane to enter and navigate through the backyard of a home. The landscapers often maneuver the truck and crane through the side yard which may not be wide enough or may be fenced in, or the landscapers often use a sufficiently large crane to lift the heavy object over the roof of the house, creating the potential for damage to the roof of the home.

Additionally, using trucks to move the heavy objects can create ruts and leave large tire tracks in existing landscapes that are expensive to fix. The extra expense is especially problematic when the project is relatively small such that the cost to fix any landscape damage is a large proportion of, or outweighs, the cost of the project itself.

As such, a need exists for a device and method to deliver heavy objects to areas with limited access, while minimizing damage to the existing landscape.

### SUMMARY OF THE INVENTION

The present invention provides a system and method for moving and placing objects in areas of limited accessibility. The present invention may be used in landscaping, for example, to move heavy objects (e.g., boulders) or difficult to handle objects (e.g., cacti).

One embodiment of the present invention may include an overhead crossbar, a plurality of vertical posts, a hoist which may be operated by an engine or battery, pneumatic wheels, a drive mechanism configured to drive at least one wheel, and a steering mechanism configured to move the invention. The invention may also include a power-operated winch. The drive mechanism may be configured to drive at least two wheels and may include an engine, a belt speed reducer, a drive axle differential, a centrifugal clutch, and pneumatic wheels. The drive mechanism may also include a hydraulic system. The steering mechanism may include a steering post and a bearing for steering by a pedestrian or a hydraulic system. The hydraulic system may include hydraulic motors, pumps and lines, and may be configured to steer the device by changing the relative speed of at least two wheels. The invention may be constructed with an overall width not exceeding about 38 inches.

Another exemplary embodiment of the present invention may include an overhead main crossbar, a plurality of vertical posts, a hoist which may be battery or motor operated, pneumatic wheels, a front and/or rear winch, a drive mechanism configured to drive at least one or two wheels and a steering mechanism. The drive mechanism may include an engine, a belt speed reducer, a drive axle differential, a centrifugal clutch and pneumatic wheels or may be a hydraulic system. The steering mechanism may include a steering post and bearing configured to be steered by a pedestrian or may be hydraulic system with at least one lever to control at least one pneumatic wheel and may include a driver platform. The invention may be constructed having an overall width not exceeding about 38 inches. The structure of the invention may include welded structural steel tubing.

### BRIEF DESCRIPTION OF THE DRAWINGS

The figures in this document illustrate various exemplary embodiments of the present invention, wherein like reference numerals represent like elements. Embodiments of the present invention may include part or all of the features shown in one of these drawings, or may include features from two or more figures. Embodiments of the present invention may also include features described in the specification, or limitations to features described in the specification. Furthermore, embodiments of the present invention may include features that would be familiar to a person of ordinary skill in the art having studied this document.

FIG. 1 is a side view of an exemplary embodiment of the present invention.

FIG. 2 is an isometric view of the exemplary embodiment illustrated in FIG. 1 showing an exemplary hoist, drive and steering mechanisms.

FIG. 3 is a rear view of an exemplary embodiment of the invention showing an exemplary drive mechanism.

FIG. 4 is a top or plan view indicating the pivotal movement of an exemplary embodiment of the invention over a heavy object.

FIG. 5 is an isometric view of another exemplary embodiment with two main crossbars, large rear pneumatic tires and an alternate steering mechanism.

FIG. 6 is a side view of the exemplary embodiment of FIG. 5 showing an exemplary driver platform.

FIG. 7 is a top or plan view of the exemplary embodiment of FIG. 5 indicating an exemplary pivotal movement of the invention over a heavy object.

FIG. 8 is a rear view showing exemplary driving and steering mechanisms of the embodiment shown in FIG. 5.

### DETAILED DESCRIPTION OF EXEMPLARY EMBODIMENTS

The present invention includes a system and method for moving difficult to handle, large and/or heavy objects. While the invention may be described in one embodiment with respect to boulders, the invention may include any objects such as, for example, landscape boulders, statues, cactuses, trees, fountains, building supplies, bags of materials, tools, structural parts, plants, machine parts and/or the like. In some embodiments, the invention includes a device and method for moving large and/or heavy objects through (or into) narrow or hard to reach areas. However, the invention may include multiple embodiments wherein one machine may be wider with more powerful and stronger components to handle larger objects (e.g., 4-5 tons) and another machine may be narrower with smaller components to move smaller objects into narrow areas.

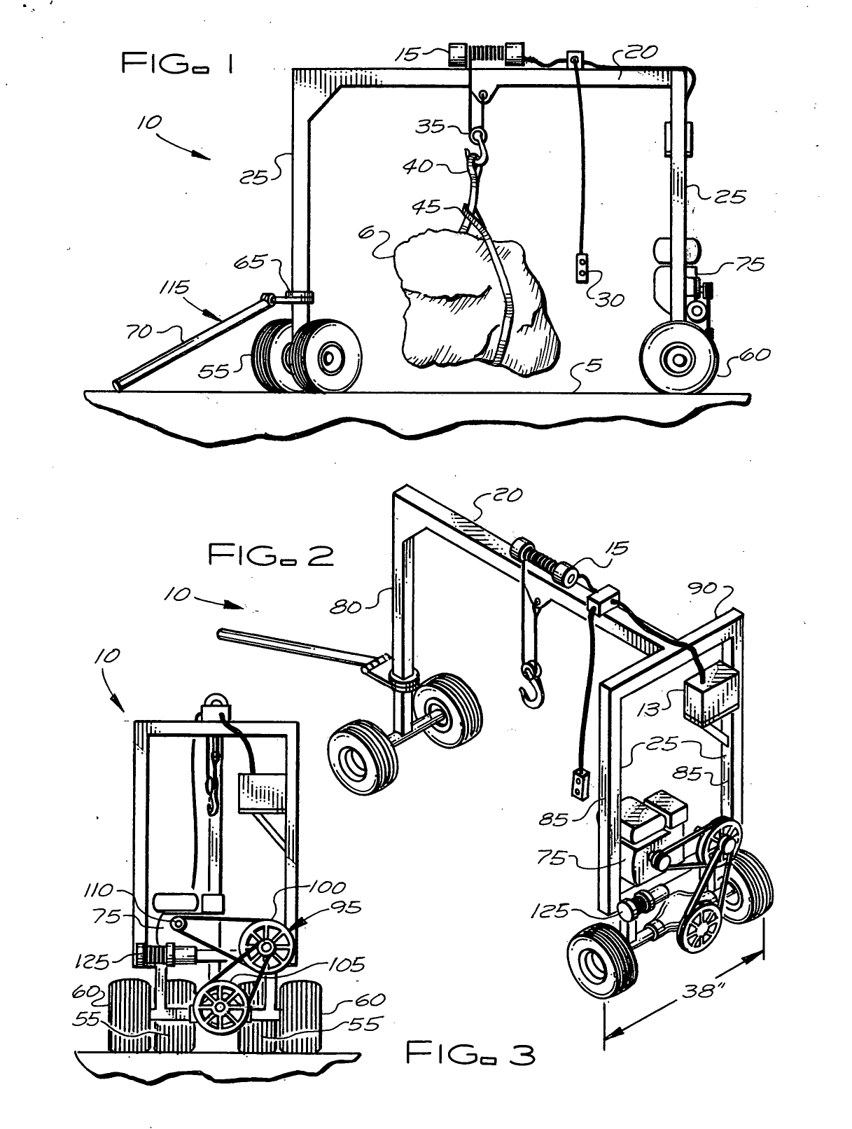

FIG. 1 shows an exemplary embodiment of the device 10 for moving objects used in landscaping, or a device for moving boulders. Device 10 may include a hoist 15 mounted on a movable structure. The structure may include main crossbar 20. Device 10 may be moved to a desired location on ground surfaces 5. The main crossbar 20 may be mounted overhead on at least one vertical post 25 and the vertical post or posts 25 may be supported by front wheels 55 and rear wheels 60 which allow device 10 to be moved. Wheels 55 and 60 may have pneumatic tires. Hoist 15 may be configured to lift an object, such as boulder 6, from near the middle of crossbar 20, and crossbar 20 may be supported at its ends, for example, by posts 80 and 85 as shown.

Hoist 15 may be power operated, and may be located near or lift from the middle of crossbar 20. FIG. 1 also shows hoist 15 may be controlled using a hoist control device 30. Hoist 15 may have a 9-ton capacity, for example.

Hoist control device 30 may be an electronic control and may be mounted on or suspended from the vertical posts 25 or main crossbar 20. A pendant type control device 30 is shown in FIGS. 1 and 2, as an example. In another embodiment, the hoist control 30 may be a hand held remote control device (e.g., radio, infrared, etc). A sling 40 or other carrying device 45 (e.g., bucket, claw, scoop, webbing, chain, rope, cable) may be affixed to the hoist 15.

In the exemplary embodiment illustrated, device 10 contains a hook 35 and a sling 40. Sling 40 may be wrapped around the object, such as a boulder 6, to temporarily secure boulder 6 to device 10. Hoist 15 may then lift boulder 6 off the ground surface 5. Once boulder 6 is clear of the ground 5, device 10 may be moved to a different location to move boulder 6.

FIG. 1 shows an embodiment where the steering mechanism 115 consists of front pneumatic wheels 55, a bearing 65 and a steering post 70. The front pneumatic wheels 55 may be rotatably mounted on the bearing 65 such that the steering post 70 may be inserted or affixed in order to allow for manual steering of the front pneumatic wheels 55. Steering post 70 may be operated by a pedestrian or other device (e.g., All Terrain Vehicle) who walks along with device 10 to steer device 10 while it is being moved.

Device 10 may have a power-operated drive mechanism that may be configured to drive one or more wheels to propel or move device 10. The drive mechanism may include an electric motor or internal combustion engine, and may include one or more gear reducers, a belt speed reducer which may include belts and pulleys, a centrifugal clutch, a transmission, a differential, an axle, a hydraulic system, or the like. In the exemplary embodiment illustrated, engine 75 may drive the two rear pneumatic wheels 60 through other components of the drive mechanism such that the device 10 is moved to the desired location. While device 10 is moving, the front pneumatic wheels 55 may be used to steer the device 10 in the appropriate direction. The direction of the device 10 may be adjusted using the steering mechanism 115 to allow device 10 to navigate through a narrow opening (e.g., gate, door, courtyard, low roof area, small room) or other difficult to access area. When the device 10 reaches the desired location, the engine 75 may be slowed down or stopped to halt the movement of device 10. In some embodiments, device 10 may have brakes to stop it and/or hold it in place. These bakes may be located, for example, on wheels 55, 60, or both, or within the drive mechanism. The hoist 15 may then be activated to lower the object, such as boulder 6, in the appropriate position.

As best shown in FIG. 2, in an exemplary embodiment the vertical posts 25 include a single front vertical post 80 and two rear vertical posts 85. In this exemplary embodiment there may also be a transverse crossbar 90 joining the top ends of the rear vertical posts 85 as well as main crossbar 20 which extends from the top of the front vertical post 80 to about the center of the transverse crossbar 90. Front and rear pneumatic wheels 55 and 60 may be mounted to the bottom ends of the vertical posts 25, which may involve other structure and components such as axles and the like. An engine 75 used to drive the pneumatic wheels 55 and 60 is shown mounted to the rear vertical posts 85.

As illustrated, hoist 15 may be mounted to about the center of the main crossbar 20. The crossbar configuration may resemble an arch, thereby allowing the object, such as boulder 6, to be hoisted under the main crossbar 20 and between the vertical posts 25. The hoist 15 and rear winch 125 may be powered by a battery 135 mounted on device 10, or may be powered by engine 75. Engine 75 may drive an alternator or generator, which may charge battery 135 or power hoist 15 or winch 125. In other embodiments, hoist 15, winch 125, or both may be human powered such as by operating a leaver, turning a crank, or pulling a chain. In still other embodiments, a block and tackle may be used. In some embodiments, device 10 may have more than one lifting device, such as hoist 15, so that objects can be lifted independently from more than one attachment point, or more than one object may be lifted independently. In some embodiments, hoist 15 may double as winch 125, or vice versa, by redirecting the cable or wire rope.

In one embodiment, the maximum width of the device 10 may be about 38 inches to allow the device 10 to fit through small openings such as yard gates, between adjacent buildings, between trees, or the like. One skilled in the art will appreciate that the main crossbar 20, transverse crossbar 90 and vertical posts 25 may be in another suitable configuration and in some embodiments are not limited to vertical and/or horizontal configurations.

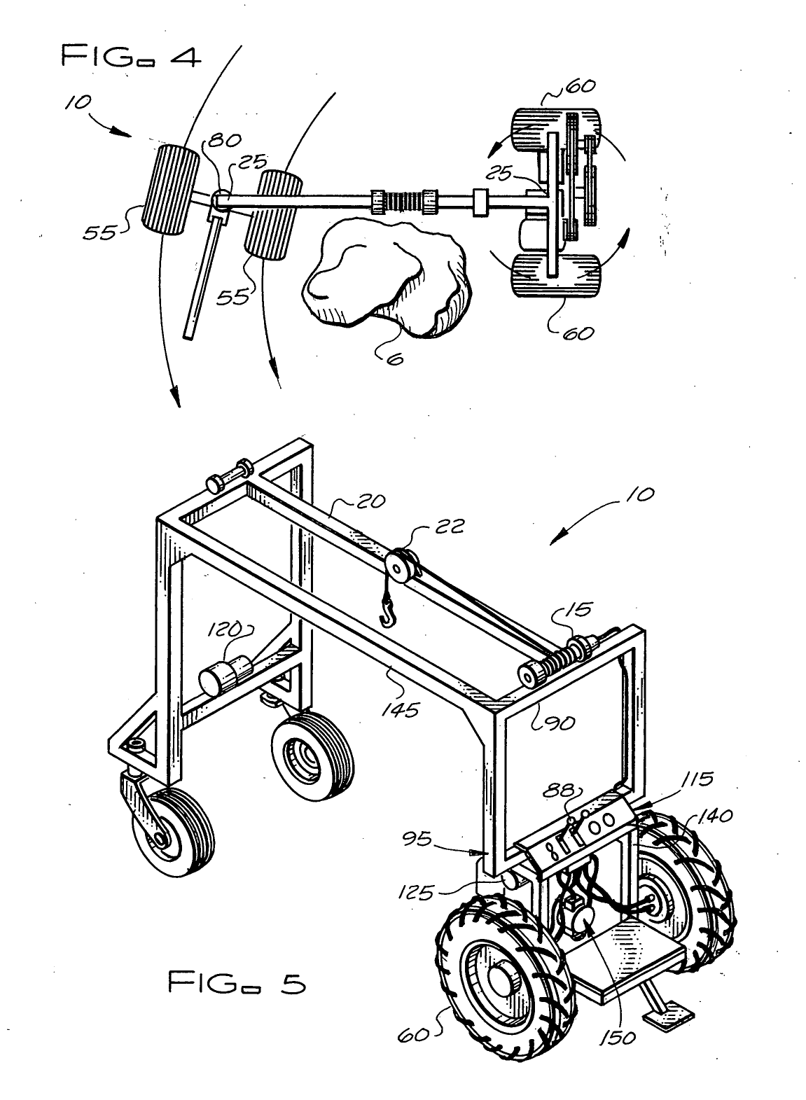

FIG. 3 shows an embodiment where the drive mechanism 95 may include a an engine 75, a belt speed reducer 100 (e.g., two stages of belts and pulleys), a drive axle differential 105, pneumatic wheels 60 and a centrifugal clutch 110. The engine 75 may be, for example, a 5 hp engine, and may be a spark-ignition internal combustion engine. After locating an object which needs to be moved to a new location, the user may manually push or pull the device 10 near the object, use the rear winch 125 to move or pull the device 10 to the object, or start the engine 75 and allow the engine 75 to drive the pneumatic wheels 60 moving device 10 toward the object. The user may steer the device using the steering mechanism 115 as shown in FIG. 1.

FIG. 4 illustrates that the front pneumatic wheels 55 may rotate or steer through various angles relative to crossbar 20, for example, and that the front pneumatic wheels 55 may be rotated as much as about 90 degrees in some embodiments to allow the device 10 to be moved over a large object. In some embodiments, device 10 may be rotated about a point midway between rear wheels 60 to locate hoist 15 over an object to be lifted such as boulder 5. The rear pneumatic wheels 60 may also rotate in order to place the hoist 15 above the large object. The user may push or pull the front vertical post 80 around the object in order to place the object below the hoist 15 and between the vertical posts 25.

FIG. 5 illustrates that in another exemplary embodiment, the steering mechanism 115 may have levers 88 to control the rear pneumatic wheels 60. For example, a method to turn device 10 may involve having a lever 88 that controls each rear pneumatic wheel 60 such that one lever 88 may be pulled toward the driver to rotate a rear pneumatic wheel 60 backward while one lever 88 may be pushed away from the driver to rotate another pneumatic wheel forward, thus turning device 10.

FIG. 5 also illustrates an embodiment of device 10 in which second main crossbar 145 may be added to the device 10 for support, and the location of the hoist 15 may be moved from the main crossbar 20 to the transverse crossbar 90.

Although moved, hoist 15 may still be configured to lift from near the middle of crossbar 20 via pulley 22 as shown. Additionally, the rear pneumatic wheels 60 or the tires thereon may be enlarged which may increase load capacity or traction, for example, on uneven or soft surfaces. The device 10 may also include a front winch 120 and a rear winch 125 to help pull the device 10 up or through difficult to access areas or to climb steep hills or move over soft ground.

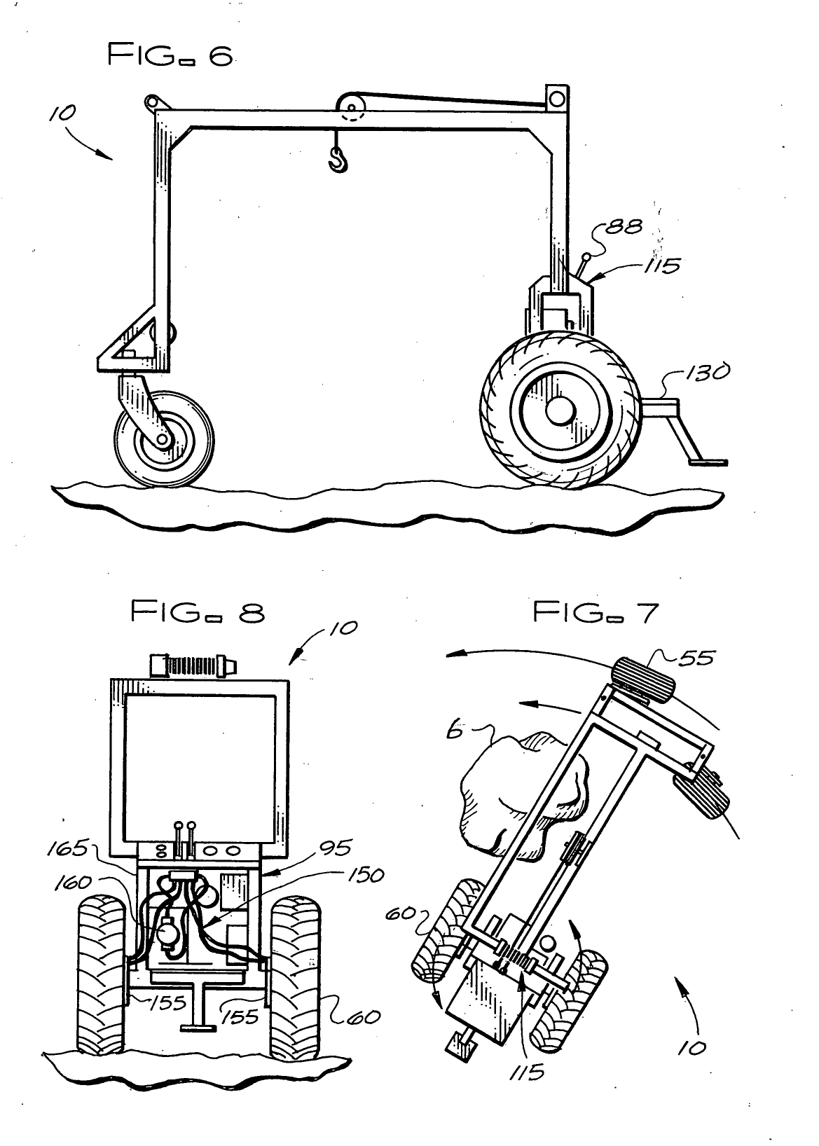

FIG. 6 illustrates one embodiment in which the device 10 may include a platform 130 to allow the operator to ride on the device 10 while controlling the steering mechanism 115, and provide increased height for visibility.

In one embodiment as shown in FIG. 7, the steering mechanism 115 may include differential driving of the two rear pneumatic wheels 60. The two front pneumatic wheels 55 may be free or partially free such that each pneumatic wheel 50 may independently caster, thereby allowing alignment of the device 10 over an object. Hydraulic system 150 may serve not only as a drive mechanism, but also as a steering mechanism. For instance, hydraulic system 150 may be configured to change the relative speed of rotation of at least two wheels, for example, wheels 60, to steer device 10. FIG. 7 illustrates how one rear pneumatic wheel 60 is driven forward and one rear pneumatic wheel 60 driven backward, and the front pneumatic wheels 55 align perpendicular to the fore aft axis of the system such that the entire device 10 swings over or near the boulder 5.

FIG. 8 shows that drive mechanism 95 may include a hydraulic system 150 which may include hydraulic motors 155, hydraulic pump or pumps 160 and hydraulic lines 165. Hydraulic motors 155 may be attached to each of the rear pneumatic wheels 60. Hydraulic lines 165 may deliver hydraulic oil from pump or pumps 160 to motors 155, through hydraulic valves operated by leavers 88. Hydraulic lines may also carry the hydraulic oil back to pump or pumps 160. Hydraulic system 150 may also include a reservoir, filter, pressure relief valve(s), an oil cooler, a sight gauge, a pressure gauge, and the like. In some embodiments, hoist 15, winch 120 and/or winch 125 may by hydraulically operated and may be operated by hydraulic system 150. In some embodiments, hoist 15 may include a hydraulic cylinder. An embodiment of drive mechanism 95 including a hydraulic system 150 may reduce or eliminate the need for a centrifugal clutch 110, drive axle differential 105 or belt speed reducer 100 which may used in other embodiments.

The detailed description of exemplary embodiments of the invention herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Reference Number Key

| | |
|---|---|
| 5 | GROUND |
| 6 | BOULDER |
| 10 | DEVICE |
| 15 | HOIST |
| 20 | MAIN CROSSBAR |
| 25 | VERTICAL POST |
| 27 | DRIVING MECHANISM |
| 30 | HOIST CONTROL DEVICE |
| 35 | HOOK |
| 40 | SLING |
| 45 | CARRYING DEVICE |
| 55 | FRONT PNEUMATIC WHEELS |
| 60 | REAR PNEUMATIC WHEELS |
| 65 | BEARING |
| 70 | STEERING POST |
| 75 | ENGINE |
| 80 | FRONT VERTICAL POST |
| 85 | REAR VERTICAL POST |
| 88 | LEVER |
| 90 | TRANSVERSE CROSSBAR |
| 95 | DRIVE MECHANISM |
| 100 | BELT SPEED REDUCER |
| 105 | DRIVE AXLE DIFFERENTIAL |
| 110 | CENTRIFUGAL CLUTCH |
| 115 | STEERING MECHANISM |
| 120 | FRONT WINCH |
| 125 | REAR WINCH |
| 130 | PLATFORM |
| 135 | BATTERY |
| 150 | HYDRAULIC SYSTEM |
| 155 | HYDRAULIC MOTOR |
| 160 | HYDRAULIC PUMP |
| 165 | HYDRAULIC LINES |

1. A device for moving objects used in landscaping, the device comprising:
a structure comprising an overhead crossbar having two ends and a middle, and a plurality of vertical posts arranged to support said ends of said crossbar;
a power-operated hoist located and configured to lift the object from near said middle of said crossbar;
a plurality of wheels located and configured to support said device, each said wheel having a pneumatic tire;
a power-operated drive mechanism configured to drive at least one said wheel to move said device; and
a steering mechanism configured to steer said device when said device is being moved by said drive mechanism.

2. The device of claim 1 further comprising a power-operated winch configured to move said device.

3. The device of claim 1, said drive mechanism being configured to drive at least two said wheels.

4. The device of claim 1, said drive mechanism comprising an engine, a belt speed reducer, a drive axle differential, and a centrifugal clutch.

5. The device of claim 1, said steering mechanism comprising a steering post and bearing for a pedestrian to steer said device.

6. The device of claim 1, said drive mechanism comprising a hydraulic system.

7. The device of claim 5, said hydraulic system comprising at least two hydraulic motors configured to drive at least two said wheels, said hydraulic system being configured to change the relative speed of rotation of said at least two wheels to steer said device.

8. The device of claim 1 having an overall width not exceeding 38 inches.

9. The device of claim 1 further comprising a battery, said battery being configured to power at least said hoist.

10. A device for moving boulders, the device comprising:
a structure comprising an overhead main crossbar having two ends and a middle, and a plurality of vertical posts arranged to support said ends of said crossbar;
a power-operated hoist located and configured to lift the object from near said middle of said main crossbar;
a plurality of wheels located and configured to support said device, each said wheel having a pneumatic tire;
a power-operated drive mechanism configured to drive at least one said wheel to move said device, said drive mechanism comprising an engine, said drive mechanism being configured to drive at least two said wheels; and
a steering mechanism configured to steer said device when said device is being moved by said drive mechanism.

11. The device of claim 10 further comprising a power-operated winch configured to move said device.

12. The device of claim 10, said drive mechanism comprising an engine, a belt speed reducer, a drive axle differential, and a centrifugal clutch.

13. The device of claim 12, said steering mechanism comprising a steering post and bearing configured to be moved by a pedestrian to steer said device.

14. The device of claim 10, said steering mechanism comprising at least one lever configured to control at least one said wheel and a platform configured to be used by a driver to steer said device.

15. The device of claim 10 further comprising a battery, said battery being configured to power at least said hoist.

16. The device of claim 10 having an overall width not exceeding 38 inches.

17. The device of claim 10, said drive mechanism comprising a hydraulic system.

18. The device of claim 17, said hydraulic system configured to drive at least two said wheels, said hydraulic system also being said steering mechanism, said hydraulic system being configured to change the relative speed of rotation of at least two said wheels to steer said device.

19. The device of claim 18 having an overall width not exceeding 38 inches.

20. The device of claim 10, said structure comprising welded structural steel tubing.
